(19) United States
(12) Patent Application Publication
(10) Pub. No.: US 2026/0124819 A1
(43) Pub. Date: May 7, 2026

(54) SHAPED PART FOR MANUFACTURING PIECES OF FURNITURE, HAVING INCREASED STABILITY DUE TO MATERIAL FIBERS AND HAVING A DEFINED QUANTITY OF ADHESIVE LAYER APPLIED, PROCESS FOR MANUFACTURING SAID SHAPED PART, AND USE

(71) Applicant: puren GmbH, Überlingen (DE)

(72) Inventors: Maximilian KARA, Aschaffenburg (DE); Martin KRAUSS, Lützelback (DE); Andreas SCHÖHL, Elsenfeld (DE)

(21) Appl. No.: 19/130,028

(22) PCT Filed: Nov. 14, 2023
(86) PCT No.: PCT/EP2023/081746

§ 371 Date: Jun. 13, 2025

(30) Foreign Application Priority Data
Nov. 15, 2022 (EP) 22207501.2

(51) Int. Cl. B32B 7/12; B32B 9/00; B32B 15/04; B32B 15/20; C08J 5/12; C08J 7/04; C08K 7/06

(52) U.S. Cl. CPC B32B 7/12; B32B 9/002; B32B 15/046; B32B 15/20; C08J 5/124; C08J 7/0427; C08K 7/06; B32B 2255/26; B32B 2266/0278; B32B 2307/718; B32B 2307/72; B32B 2307/7376; B32B 2311/24; B32B 2479/00; C08J 2375/04; C08J 2433/04; C08J 2467/00; C08J 2475/04

(57) ABSTRACT

A shaped part is composed of a polyurethane piece and two outer layers, the shaped part is furthermore, because of its structure suitable for producing pieces of furniture and, because of the composition of the polyurethane piece and its production using material fibers with a defined application quantity of the adhesive layer, has increased stability with respect to the conventional prior art shaped parts which are used in the production of pieces of furniture, and a method for producing the shaped part and the use of the shaped part for producing pieces of furniture and the pieces of furniture produced from the shaped part.

### CROSS-REFERENCE TO RELATED APPLICATIONS

This patent application is a U.S. national stage application of international patent application PCT/EP 2023/081746, filed on Nov. 14, 2023, which is based on and claims priority to European patent application EP 22207501.2, filed on Nov. 15, 2022, the contents of which are incorporated herein by reference.

### FIELD

The invention relates to a shaped part composed of a polyurethane piece and two outer layers, which because of its structure is suitable for producing pieces of furniture and, because of the composition of the polyurethane piece and its production using material fibers with a defined application quantity of the adhesive layer, has increased stability with respect to the conventional shaped parts from the prior art, which are used in the production of pieces of furniture. The invention also relates to a method for producing the shaped part and to the use of the shaped part for producing pieces of furniture and to the pieces of furniture produced from the shaped part.

### BACKGROUND

Pieces of furniture have long been known in human history and can be produced from a variety of materials. Aluminum has proven to be very suitable for pieces of furniture because it has a low specific weight and good mechanical stability. It is therefore possible to produce pieces of furniture which are easily portable and are also durable and load-bearing. In addition, aluminum is stable in air and can be treated in such a way that it has a glossy and optically attractive surface. Herein the aluminum is usually provided in the form of pipes or tubes from which the load-bearing frames of the pieces of furniture are manufactured. Depending on the desired construction of the respective piece of furniture, walls or pieces of wall can also be produced from aluminum, for example as panels. In principle, however, all materials are suitable for the production of pieces of furniture, wherein those materials which have a low specific weight and good mechanical stability are preferred.

In the production of the pieces of furniture, the problem comes up that the parts provided for the production of the piece of furniture must be fastened to one another. In the mutual fastening of the parts, screw connections are very often used. These have the advantage of being releasable and can moreover be provided for the desired purpose such that they have a certain screw depth, for example depending on a desired fastening strength. However, the aluminum structure is often less suitable for screw threads because it does not have a sufficient thickness and many material parts provided for the production of pieces of furniture are hollow. For this reason, solutions have been proposed in the prior art, providing the inner hollow space of the material parts intended for the production of pieces of furniture with fillers which lead to an only insignificant increase of the weight of pieces of furniture but fill the hollow spaces with solid material for improved mechanical strength.

The document CN102242560A describes a matted composite material of an aluminum-plastic composite material, which consists in succession of a matted aluminum plate, a first polymer binder film, a polyurethane inner layer, a polymer adhesive film and a further aluminum plate, with a total of five layers. This composite material which is matted on one side is in particular used for the production of high-end quality pieces of furniture, for example in indoor spaces and automobiles. The document does not give any indications regarding the construction of the pieces of furniture themselves and also not regarding the mechanical strength of the described composite material.

The document EP2796258A2 describes a two-dimensional electrical surface conductor with an insulating layer, which comprises a 5 mm thick layer of polyurethane foam, two electrically conductive aluminum foils, two layers of a 5 mm thick natural cork agglomerate, furthermore LED light-emitting diodes with electrodes having different lengths and having at their ends an epoxy varnish layer for insulation, and and electric power source. Due to the cork layer, the surface conductor provides an insulating and at the same time mechanically flexible inner layer for the installation of electrical components for the production of an electrical component with an electrically conductive surface. The document also mentions the possible production of pieces of furniture from the two-dimensional electrical surface conductor. The document likewise does not give any indications regarding the construction of the pieces of furniture themselves and also not regarding the mechanical strength of the described two-dimensional electrical surface conductor.

The document DE202016106033U1 describes a panel with a core made of an extruded rigid foam, which is provided on at least one surface side with a cover layer made of a high-pressure laminated material (HPL), wherein the panel has on its end faces a layer of a weathering-resistant synthetic material for edge covering. In an embodiment of the described invention, the core of the panel consists of a closed-cell extruded polystyrene (XPS), and the end face layer for the edge covering consists of a thermoplastic synthetic material. The described panel is suitable, for example, for tabletops of garden furniture or tables for outdoor gastronomy or other furniture standing permanently outdoors, such as for example furniture in public spaces.

There is therefore demand for materials for the production of pieces of furniture which are constructed from two outer layers as a structuring component and which comprise in their interior a filler having sufficient mechanical strength and depth for a fastening of connecting fastening means. These connecting fastening means are typically screws. Furthermore, the material should not involve any restrictions with regard to the optical appearance of the surface compared with an aluminum surface from the prior art and should have a low specific weight for the easy portability of the pieces of furniture. The material should be present as a shaped part and should ideally be present in the form of panels which can then be assembled to form the desired pieces of furniture.

The task at hand is therefore to provide shaped parts having two outer layers as a structuring component, which are suitable for the production of pieces of furniture and have increased mechanical stability compared with the shaped parts from the prior art. The task is also to provide a method for producing these shaped parts.

### SUMMARY

The present invention solves this task by means of a shaped part which is suitable for the production of pieces of furniture and which, in a rectilinear see-through view, is composed of an inner layer consisting of a polyurethane piece that has a density of 400-700 kg/m³ and is composed of chopped and compressed shreds of polyurethane material mixed with material fibers, and which has two outer layers, the outer layers having a thickness of 0.10 mm to 4.00 mm, and the adhesive layer having an application quantity of 40 to 600 g/m².

What is claimed is a shaped part for the production of furniture, comprising an inner layer composed of a polyurethane piece and two outer layers, and comprising between the outer layers and the inner layer respectively one adhesive layer, with a further adhesive layer on the other side of the polyurethane piece, and which is characterized in that the polyurethane piece of the inner layer is composed of chopped and compressed shreds of polyurethane material mixed with material fibers and a binder and has a density of 400-700 kg/m³, and the outer layers have a layer thickness of 0.10-4.00 mm, and the adhesive layers have an application quantity of 40 to 600g/m².

The denominations of the individual layers refer to a rectilinear see-through view through the shaped part. If the shaped part has a panel shape, two outer layers are applied onto the inner layer. If the shaped part is a pipe or a tube, the number of the two outer layers is given for a rectilinear see-through view through the pipe or the tube. For a pipe or a tube, the two outer layers then form a radial outer layer.

In an embodiment of the invention, the material fibers are particles of inorganic material fibers. Examples of inorganic material fibers are rock fibers, glass fibers, ceramic fibers or basalt fibers. It is also possible to use inorganic material fibers of minerals. In a further embodiment of the invention, the material fibers are particles of organic material fibers. Examples of organic material fibers are carbon fibers. In a typical embodiment, particles of inorganic material fibers or of organic fibers are used for the production of the shaped part according to the invention. However, it is likewise within the scope of the invention to use mixtures of particles of inorganic material fibers and organic material fibers. An example of a material containing material fibers is given by the document EP3371250B1.

The material fibers of the present invention usually have a weight of 0.0005 to 2.00 g. An optimal mechanical strength of the piece of polyurethane is achieved by this weight of the material fibers. In an embodiment, the material fibers can also have a weight of 0.001 to 0.5 g. In a further exemplary embodiment, the material fibers have a weight of 0.01 to 0.2 g.

For an implementation of the invention, the outer layer should have a layer thickness of 0.10 mm to 4.00 mm. In an embodiment of the invention, the outer layer has a layer thickness of 0.80 mm to 2.00 mm. These layer thicknesses have been found to be optimal both for the production of the pieces of furniture and for the stability of the pieces of furniture and their specific weight obtained in this way.

According to the invention, an application quantity of 40 to 600 g/m² has been found to be especially advantageous for the adhesive layer. As a result, an optimal ratio of adhesive strength and weight is achieved. As a result, the ratio of adhesive strength and weight is further optimized. It is also possible to use a narrower range of, for example, 80 to 160g/m². This narrower range is very material-friendly for the materials used. As a result of the defined application quantity, the adhesive layer no longer has to be provided with an epoxy primer. An epoxy primer is recommended only if an aluminum panel is selected as the outer layer and a 1 K-PUR prepolymer is selected as the adhesive layer.

The chopping and pressing of polyurethane material shreds is known in the prior art and is described, for example, in the document DE10228473A1. Binders such as are described, for example, in the document U.S. Pat. No. 3,717,597A are suitable as binders for the chopped and compressed shreds of polyurethane material and the material fibers. An epoxy primer is described, for example, in the document DE3042788A1.

In a preferred and practicable embodiment of the shaped part, the outer layer of the shaped part is made of aluminum. This material has a low specific weight and is resistant and durable. Aluminum is also insensitive to the effects of weathering. In addition, aluminum can be provided in an optically attractive outer shape. The outer layer has the same shaping as the shaped part and, in a popular embodiment, is made of aluminum. If the shaping of the outer layer is a panel and the panel is made of aluminum, the outer layer that is made of aluminum is realized as an aluminum panel.

In a further embodiment of the shaped part, the outer layer is made of a stone veneer. Like aluminum, said stone veneer has a low specific weight and an externally aesthetic effect. The stone veneer is inexpensive to produce.

In a further embodiment of the shaped part, the material of which the outer layer is made is selected from high-pressure pressed laminate, continuously pressed laminate, carbon fiber, resin-bound textiles, concrete, mineral-bound materials, ceramic materials, glasses, metals, weathering-resistant synthetic materials or precious woods. These materials constitute further embodiments of the outer layer, which differ in the outer appearance of the outer layer depending on the use and on the wishes of the end product user. These materials also have a relatively low specific weight and good durability.

The metals of which the outer layer can likewise be realized are, for example, brass, zinc or copper. Compared to aluminum, these metals have a somewhat higher specific weight, but are also resistant and durable. These metals moreover have a different outer appearance than aluminum, so that different wishes of the end product user with regard to the outer appearance of the end product may also be accommodated depending on the use of the end product.

The weathering-resistant synthetic materials are, for example, polymethylene methacrylate (PMMA), polyvinyl chloride (PVC), polyethylene (PE) or polyurethane (PU). These synthetic materials are inexpensive and easy to handle. The precious woods are, for example, teak or mahogany. These precious woods have an externally aesthetic effect and are also relatively weathering-resistant compared to other woods.

It is possible to combine any of the mentioned materials for the outer layer with one another depending on the wishes of the user of the end product and depending on the desired appearance.

In an exemplary embodiment, the adhesive layer is made of a 1 K-PUR prepolymer. This adhesive hardens quickly and connects the parts that are to be glued reliably and permanently. An adhesive layer of a 1 K-PUR prepolymer is described, for example, in the document WO2017121540A1.

In a further embodiment of the shaped part, the adhesive layer consists of an acrylate adhesive, an in its initial state solvent-containing adhesive, a dispersion adhesive or a two-component adhesive. These adhesives are somewhat less expensive than the 1 K-PUR prepolymer and are favorably utilizable for connecting the parts that are to be glued.

In the most common embodiment of the invention, the shaped part is planar and has the shape of a panel. A panel is readily usable for the construction of pieces of furniture. In a simple embodiment, the panel is screwed with a further panel at a right angle for the construction of a deposition surface. However, it is also possible within the scope of the invention to produce a shaped part that is nor realized as a panel. In an exemplary embodiment, pipes or tubes may also be produced as a shaped part of the present invention. In principle, any geometrically possible shape may be selected for the shaped part according to the present invention.

In a further advantageous embodiment of the present invention, the polyurethane piece of the inner layer has a density of 550-660 kg/m³. This density has been found to be optimal, on the one hand, for the pieces of furniture constructed therewith still having a low weight and, on the other hand, in order to achieve sufficient mechanical stability for the screw connection.

In a further embodiment of the invention, the outer layer is varnished with a polyester varnishing, which has a layer thickness of 10-25 μm, forms the outermost layer of the shaped part and covers the outer layer, as the outermost layer. This layer thickness has been found to be optimal for a protection of the surface of the outer layer and for creating a surface which has a pleasant grip feeling and is optically attractive. This polyester layer is usually applied as the outermost layer onto all aluminum panels of the shaped part. However, it is also possible within the scope of the invention to apply the polyester layer onto only one aluminum panel, preferably in such a case onto the aluminum panel which will later form the outer side of a piece of furniture. The application of a polyester layer onto the outer layer is particularly preferred if the outer layer is made of aluminum.

What is further claimed is a method for producing the shaped part or parts described above. What is claimed is a method comprising the method steps of
chopping a polyurethane foam in a chopper to produce polyurethane shreds, and
adding a binder to the polyurethane shreds and mixing, such that a mixture is created, and compressing the mixture obtained in this way to form a polyurethane piece, and
applying an adhesive layer onto at least one side of the polyurethane piece, with a further adhesive layer on the other side of the polyurethane piece, and
pressing outer layers onto the side of the polyurethane piece on which the adhesive layers are applied,
and which is characterized in that
material fibers are added to the polyurethane shreds before the compression, and
the compression to produce a polyurethane piece is carried out with such a pressure and such a duration that after the compression the polyurethane piece has a density of 400-700 kg/m³, and
the adhesive layers are applied onto the at least one side of the polyurethane piece with an application quantity of 40 to 600 g/m².

In the most common embodiment, the method is used to produce a plurality of shaped parts, which are then assembled to form a piece of furniture. However, it is possible in principle within the scope of the invention to produce any number of shaped parts according to the invention or only one shaped part according to the invention. Within the scope of the invention, it is further possible to apply a polyester layer having a thickness of 10-25 μm, which does not come into contact with the adhesive layer, onto the outer side of the outer layer. The application of a polyester layer onto the outer layer is particularly preferred if the outer layer is made of aluminum.

In an embodiment of the invention, the compression to form a polyurethane piece is carried out with such a pressure and such a duration that after the compression the polyurethane piece has a density of 550-660 kg/m³. The density of the polyurethane piece is readily controllable by the pressure and the duration of the compression.

In a further embodiment of the method for producing the shaped part or parts described above, an aluminum layer is pressed on as the outer layer. This material has a low specific weight and is resistant and durable. Aluminum is also insensitive to the effects of weathering. In addition, aluminum can be pressed on in such a way that it has an optically attractive outer shape. The aluminum layer as the outer layer may then form an aluminum panel.

In a further embodiment of the method, a stone veneer is pressed on as the outer layer. The stone veneer is preferably produced before it is pressed on. The stone veneer may be produced by applying a resin onto stone material, applying glass fibers to the applied resin and removing the glass fibers by hand. The removed glass fibers with the stone material are then pressed on as a stone veneer onto the side of the polyurethane piece which the adhesive layer has been applied onto. The production of the stone veneer is simple and inexpensive.

For pressing on as an outer layer, the material of which the outer layer is made may be selected from high-pressure pressed laminate, continuous-pressed laminate, carbon fiber, resin-bound textiles, concrete, mineral-bound materials, ceramic materials, glasses, metals, weathering-resistant synthetic materials or precious woods. The processing of such materials for pressing on as an outer layer is known in the prior art.

If high-pressure pressed laminate or continuous-pressed laminate is used for producing a shaped part, said laminate is firstly produced in a separate method step. For this purpose, at least two paper layers are impregnated with melamine resin or phenolic resin, as a result of which a thermosetting synthetic material is produced from the melamine resin or phenolic resin after hardening. This thermosetting synthetic material is then pressed as an outer layer onto the side of the polyurethane piece which the adhesive layer has been applied onto.

In a further embodiment of the method, the metals which are pressed on as the outer layer are brass, zinc or copper. In a further embodiment of the method, the weathering-resistant synthetic materials, pressed on as the outer layer, are polymethylene methacrylate, polyvinyl chloride, polyethylene or polyurethane. In a further embodiment of the method, the precious woods, pressed on as the outer layer, are teak or mahogany.

An adhesive layer made of a 1 K PUR prepolymer can be applied as an adhesive layer onto at least one side of the polyurethane piece. This adhesive hardens quickly and connects the parts that are to be glued permanently. An acrylate adhesive, an in its initial state solvent-containing adhesive, which is allowed to dry to obtain the adhesive effect, a dispersion adhesive or a two-component adhesive can also be applied as an adhesive layer onto the at least one side of the polyurethane piece. In the case of an in its initial state solvent-containing adhesive, the solvent must first be allowed to evaporate in order to obtain the desired adhesive effect. For this, solvent-containing adhesives are somewhat cheaper to purchase and easier to handle.

The mentioned adhesives may also be used in combination.

In an embodiment of the production of the shaped part described above for the production of pieces of furniture, the production of the piece of furniture is carried out by milling a hollow space into the shaped part and screwing at least two shaped parts with one another to form a piece of furniture. The shaped parts described above are ideally suitable for this purpose. The milled-in hollow space may contain a fastening pattern. The fastening pattern may be milled into the milled-in hollow space for this purpose. In a simple embodiment, the milled-in hollow space is a milled-in cylinder and the fastening pattern is a screw thread. The fastening is then realized by means of a fastening part. In a simple embodiment, the fastening element is a screw. The milled-in hollow space and the fastening pattern have an increased stability and supply the fastening pattern with increased stability when loaded with fastening elements, in that said fastening elements do not tear out and enable a stable connection of the shaped parts to form a piece of furniture.

What is further claimed is the use of a shaped part described above for producing pieces of furniture. Although the production of pieces of furniture constitutes a preferred use of the shaped parts described above, it is in principle possible to use the shaped parts for any purpose for which they are suitable.

In the production of pieces of furniture, it is also possible to use shaped parts which are embodied as panels and are planar. In such a case, there may be open side faces which are not covered with the outer layer. These open side faces may subsequently be provided with a cover panel made of the desired material. The desired material may be aluminum, for example. For a covering, the open side faces may also be provided with a cover panel made of a suitable commercially available synthetic material. Suitable synthetic materials for this purpose are, for example, UV-stabilized polypropylene (PP), UV-stabilized polyethylene (PE), polyvinyl chloride (PVC) or acrylonitrile-butadiene-styrene copolymer (ABS). In an exemplary embodiment, the cover panel that is made of the desired material has a thickness of 0.40 mm to 2.00 mm. In an exemplary embodiment, the cover panel that is made of synthetic material has a thickness of 1.0 mm to 2.0 mm. Like the cover panel that is made of the desired material, the cover panel that is made of synthetic material may be glued on the polyurethane piece with an adhesive layer made of one of the mentioned adhesives. Preferably, a 1 K-PUR prepolymer with an epoxy primer is used for this purpose. As a result of the covering, an abutment edge is produced at the open side face by the cover panel.

What is eventually also claimed is a piece of furniture produced from one or several of the shaped parts described above.

The invention has the advantage of providing mechanically stable shaped parts for the construction of pieces of furniture. As a result of said shaped parts, these pieces of furniture are moreover characterized by a low specific weight—and thus favorable portability—and by good surface stability and by an optically attractive appearance. The shaped parts have increased stability compared with the shaped parts from the prior art, in that said shaped parts allow the secure drilling-in of screw threads.

In the following, the invention will be described in detail using twenty-one drawings, wherein said drawings only represent embodiments of the invention and the invention is not restricted to said embodiments.

### BRIEF DESCRIPTION OF THE DRAWINGS

FIG. 1 shows the shaped part with the individual layers in a non-assembled form in an oblique front view,

FIG. 2 shows the shaped part with the individual layers in a side view.

FIG. 3 shows a shaped part with a screw in a milled-in hollow space in a side view.

FIG. 4 shows a shaped part with a fastening nut above the milled-in hollow space in a front view.

FIG. 5 shows a loosely assembled shaped part with milled-in hollow spaces in an oblique side view.

FIG. 6 shows a screw for insertion into a milled-in hollow space.

FIG. 7 shows a fixedly assembled shaped part, with the screw in the milled-in hollow spaces, in an oblique side view.

FIG. 8 shows two shaped parts assembled with screws in a side view.

FIG. 9 shows a shaped part, with an object that has been put on and fastened, in a side view.

FIG. 10 shows a shaped part onto which an object is screwed with a special screw in a side view.

FIG. 11 shows a shaped part onto which an object is screwed using a special screw having a special rotary head in a side view.

FIG. 12 shows a shaped part with milled-in hollow spaces and with a dowel expansion joint in a side view.

FIG. 13 shows two shaped parts assembled using a dowel in a side view.

FIG. 14 shows two shaped parts assembled using a double turn-in dowel in a side view.

FIG. 15 shows two shaped parts, assembled using an expansion screw, in a side view.

FIG. 16 shows two shaped parts, assembled using an invisible plug connection on the narrow sides, in a side view.

FIG. 17 shows two shaped parts, assembled using an invisible plug connection on the wide sides, in a side view.

FIG. 18 shows two shaped parts, assembled using a biscuit joint, in a side view.

FIG. 19 shows two shaped parts, assembled using an angled spline, in a side view.

FIG. 20 shows the use of the shaped part for the production of a piece of furniture, from above.

FIG. 21 shows the use of the shaped part for the production of a piece of furniture, in an oblique front view.

### DETAILED DESCRIPTION

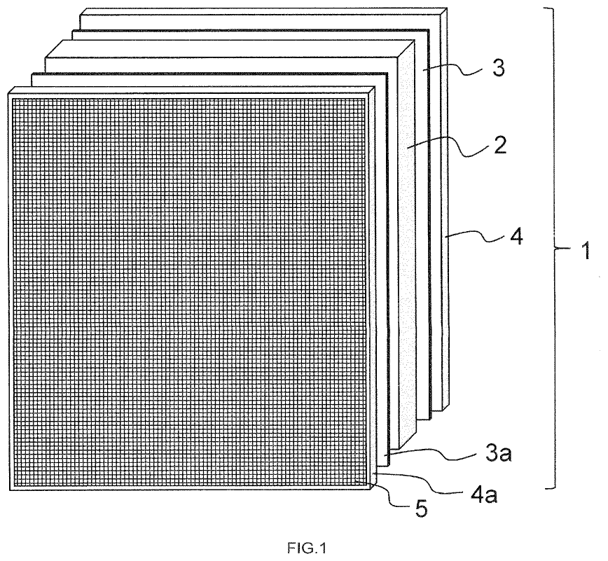

The drawing FIG. 1 shows the shaped part (1) with the individual layers in a non-assembled form in an oblique front view. The individual layers can be seen, which are assembled and thus form the shaped part (1). The innermost layer is the inner layer, which is realized as the polyurethane piece (2). The polyurethane piece (2) is obtained by chopping a polyurethane foam in a chopper to produce polyurethane shreds, adding a binder to the polyurethane shreds, adding material fibers, mixing to create a mixture and compressing the mixture obtained in this way to produce a polyurethane piece (2). The next layer, starting from the polyurethane piece (2) in a rectilinear see-through view, is the adhesive layer (3). The adhesive layer (3) is applied onto the polyurethane piece (2) with an application quantity of 40 to 600 g/m². The next layer is the outer layer (4), which is embodied as an aluminum panel. The second adhesive layer (3a) and the second outer layer (4a), as a further outer layer (4), which are applied onto the other side of the inner layer in a rectilinear see-through, can also be seen here. In this embodiment, the last layer is then the outermost layer, which is realized as a polyester varnishing (5) on the second outer layer (4a). The first outer layer (4) may also have a polyester varnishing (5) on the surface that is not visible here. In this way, the surfaces of the outer layers (4, 4a) are protected and a pleasant grip feeling is created.

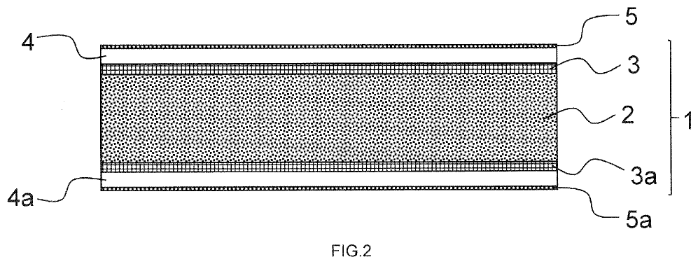

The drawing FIG. 2 shows the shaped part (1) with the individual layers in a side view. The individual layers are here assembled to form the finished shaped part (1). The inner layer, which is realized as the polyurethane piece (2), the adhesive layer (3), the outer layer (4), which is realized as the aluminum panel, and the polyester coating (5), which forms the outermost layer, can be seen. The adhesive layer (3a) on the other side of the polyurethane piece (2) and the polyester varnishing (6a) in a rectilinear see-through view on the other side of the polyurethane piece (2) can also be seen here.

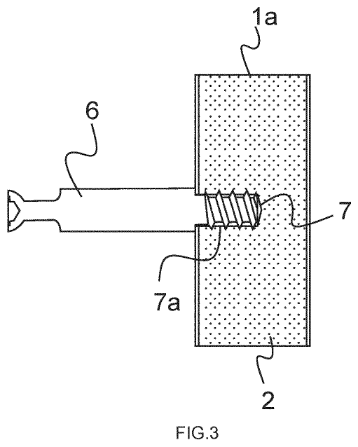

The drawing FIG. 3 shows a first shaped part (1a) with a screw (6) in a milled-in hollow space (7) in a side view. A hollow space (7) is milled into the shaped part (1), which is formed from the described layers. A screw (6) is screwed into the hollow space (7). As a result, the milled-in hollow space (7) contains a fastening pattern (7a) that is realized as a screw thread. The polyurethane piece (2) has sufficient strength to enable screwing a screw (6) in and to enable a fastening pattern (7a) being screwed in by means of the screw (6). The screw thread in the first shaped part (1a) may also be screwed in by means of a drill. The polyurethane piece (2) of the invention enables sufficient stability for this type of fastening.

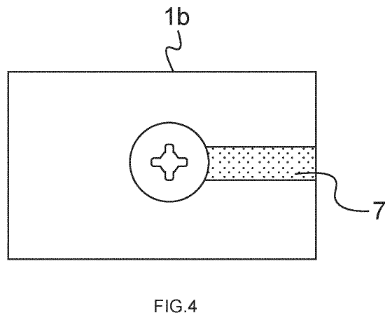

The drawing FIG. 4 shows a second shaped part (1b), with a fastening nut (8) above the milled-in hollow space (7), in a front view. A hollow space (7) has been milled into the shaped part (1). A fastening nut (8) has been introduced into said hollow space (7), such that the milled-in hollow space (7) also opens towards the fastening nut (8). This second shaped part (1b) constitutes the counterpart for a fastening of the shaped part (1) of the drawing FIG. 3. The screw (6) of the shaped part (1) of the counterpart is inserted into the milled-in hollow space (7). The fastening nut (8) is then rotated, such that the screw (6) is fastened in the milled-in hollow space (7). In this way, the two shaped parts (1a, 1b) can be fastened against each other. The polyurethane piece (2) of the invention, which cannot be seen in this figure, enables sufficient stability for this type of fastening.

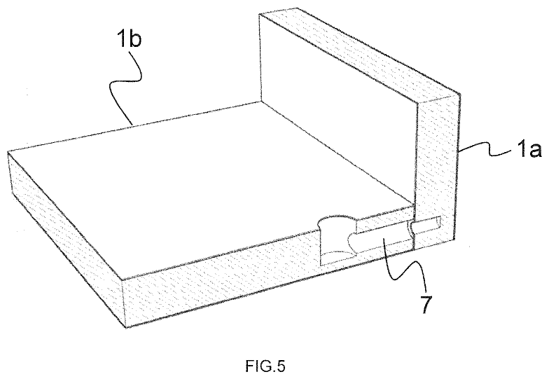

The drawing FIG. 5 shows two loosely assembled shaped parts (1a, 1b) with milled-in hollow spaces (7) in an oblique side view. The hollow spaces (7) are put in for a provided screw (6) and a provided fastening nut (8). It can clearly be seen in this drawing that the milled-in hollow space (7) opens towards the provided fastening nut (8).

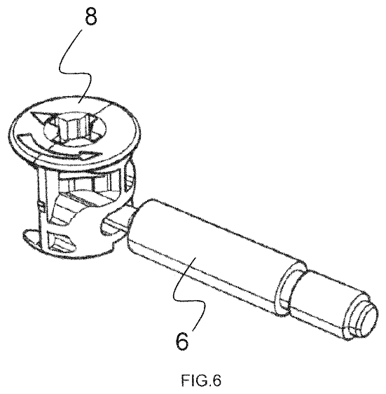

The drawing FIG. 6 shows a prior art screw (6) for insertion into a milled-in hollow space (7). In this embodiment, the screw (6) has no thread, but is fastened by means of the fastening nut (8).

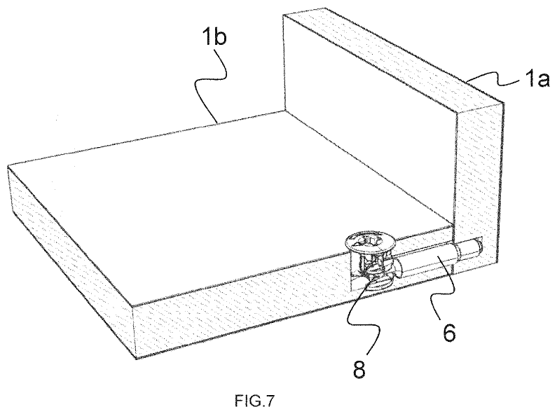

The drawing FIG. 7 shows two fixedly assembled shaped parts (1a, 1b) with the screw (6) in the milled-in hollow spaces (7) in an oblique side view. The stability of the polyurethane piece (2) enables stable screwing-in of the screw (6) and the fastening nut (8).

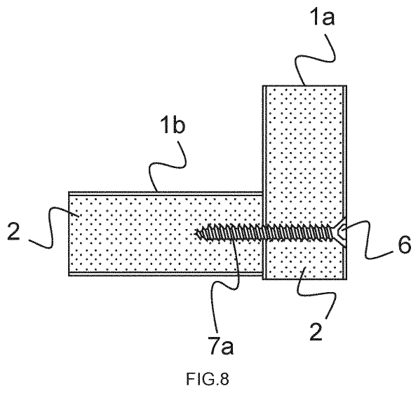

The drawing FIG. 8 shows two shaped parts (1) which have been assembled using screws (6) in a side view. Two shaped parts (1a, 1b) can be seen, which have been assembled by means of a screw (6). In this embodiment, the screws (6) have a thread. The shaped parts (1a, 1b) with the polyurethane piece (2) provide sufficient stability and strength for a fastening of the first shaped part (1a) and the second shaped part (1b) against each other using the screw (6). It is possible that for the fastening, the screw (6) is screwed into the shaped parts (1a, 1b) without further pretreatment. As a result, during the screwing-in a screw thread is created as a fastening pattern (7a). Preferably, however, the hollow space (7) is milled in and during the milling-in a fastening pattern (7a) is milled in.

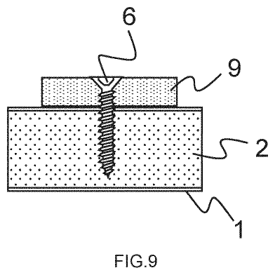

The drawing FIG. 9 shows a shaped part (1), with an object that has been put on and fastened, in a side view. A shaped part (1), with a screwed-on object (9), can be seen. The polyurethane piece (2) provides the shaped part (1) with sufficient stability such that a screw (6) can be screwed in and the object (9) can be fastened on the shaped part (1) using the screw (6).

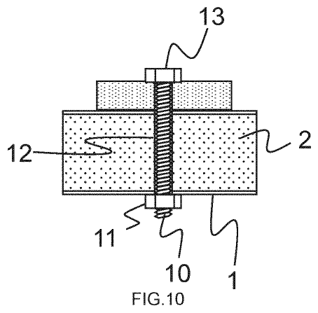

The drawing FIG. 10 shows a shaped part (1) onto which an object (9) has been screwed using a special screw (10) from the prior art, in a side view. A shaped part (1) can be seen onto which an object (9) has been screwed using a special screw (10) with a screw nut (11). The special screw (10) has a rotary head (13) and has a screw thread (12) that is fastened in the milled-in hollow space (7) using a screw nut (11). The stability of the polyurethane piece (2) enables stable screwing-in of the special screw (10).

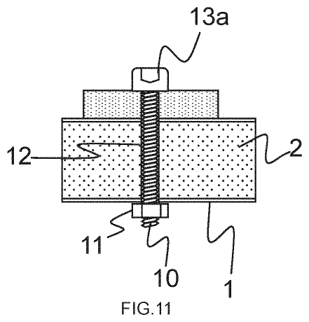

The drawing FIG. 11 shows a shaped part (1) onto which an object (9) has been screwed using a special screw (10) with a special rotary head, in a side view. A shaped part (1) can be seen onto which an object (9) has been screwed using a special screw (10) with a special rotary head (13a), in a side view. The special screw (10) has a special rotary head (13a) that can be rotated using a hex wrench. This special screw (10) with the special rotary head (13a) also has a screw thread (12), which is fastened in the milled-in hollow space (7) using a screw nut (11). The stability of the polyurethane piece (2) enables stable screwing-in of the special screw (10).

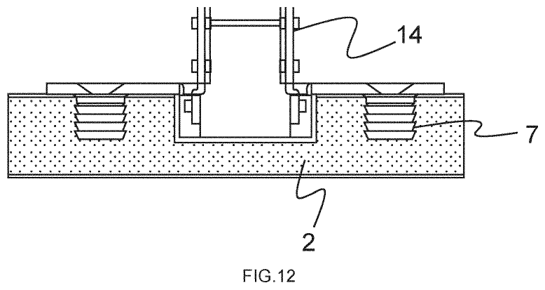

The drawing FIG. 12 shows a shaped part (1) with milled-in hollow spaces (7) and with a dowel expansion joint (14), in a side view. The dowel expansion joint (14) is embedded in the milled-in hollow spaces (7) and is expanded for fastening. This type of fastening is possible because the polyurethane piece (2) has increased stability.

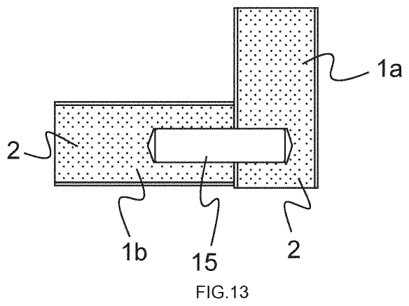

The drawing FIG. 13 shows two shaped parts (1a, 1b) assembled using a dowel (16), in a side view. The dowel (15) is driven into a shaped part (1a, 1b) and the shaped parts (1a, 1b) are fastened against each other using pressing power. This type of fastening is also possible only because the polyurethane pieces (2) have increased stability.

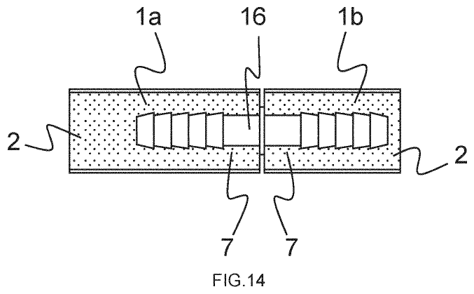

The drawing FIG. 14 shows two shaped parts (1a, 1b) assembled using a double turn-in dowel (16), in a side view. Here two shaped parts (1a, 1b) are fastened against each other using a so-called double turn-in dowel (16). Said double turn-in dowel (16) is firstly fastened in one shaped part (1a) by being driven into the milled-in hollow space (7) and is then pressed with the shaped part (1a) into the milled-in hollow space (7) of the other shaped part (1b). In this way, the two shaped parts (1a, 1b) are fastened against each other. This type of fastening is possible only because the polyurethane piece (2) has increased stability.

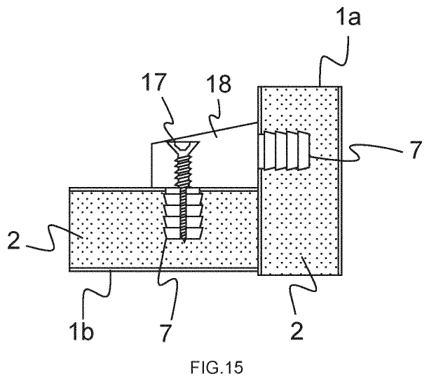

The drawing FIG. 15 shows two shaped parts (1a, 1b), assembled using an expansion screw (17), in a side view. An expansion screw (17) presses a corner fitting (18) against the milled-in hollow spaces of two shaped parts (1a, 1b). As a result of this, the two shaped parts (1a, 1b) are firmly pressed together.

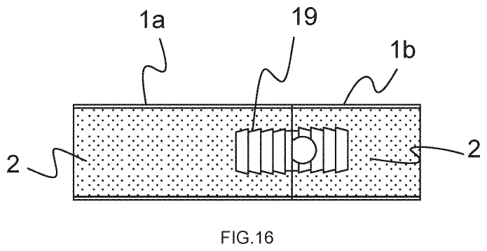

The drawing FIG. 16 shows two shaped parts (1a, 1b), assembled using an invisible plug connection (19) on the narrow sides, in a side view. The invisible plug connection (19) is pressed into the milled-in hollow spaces (7) of one shaped part (1a) and is then pressed into the milled-in hollow space (7) of the other shaped part (1b). This connection is somewhat less stable than a connection using a double turn-in dowel (16), but is suitable for a loose fastening.

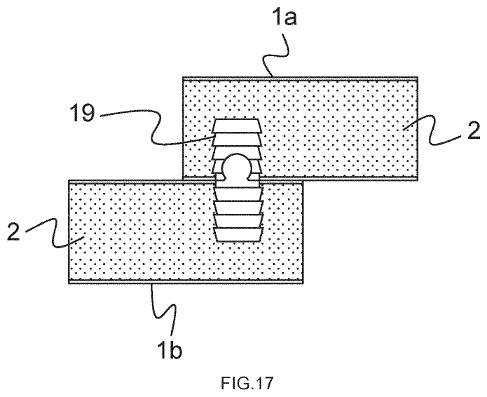

The drawing FIG. 17 shows two shaped parts (1a, 1b), assembled using an invisible plug connection (19) on the wide sides, in a side view. This fastening is realized in the same way as in the fastening in the drawing FIG. 16, whereas here the shaped parts (1a, 1b) are fastened against each other sideways.

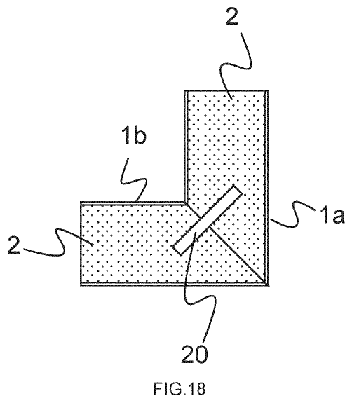

The drawing FIG. 18 shows two shaped parts (1a, 1b), assembled using a biscuit joint (20), in a side view. Two angled shaped parts (1a, 1b) can be seen, which are fastened against each other by means of a biscuit joint (20). Biscuit joints (20) are suitable for assembling angled shaped parts (1a, 1b). The biscuit joint (20) is placed into a milled-in hollow space (7) of the first shaped part (1a) and is then pressed with the first shaped part (1a) into the milled-in hollow space (7) of the other shaped part (1b). This type of fastening is possible due to the increased stability of the polyurethane pieces (2) of the two shaped parts (1a, 1b).

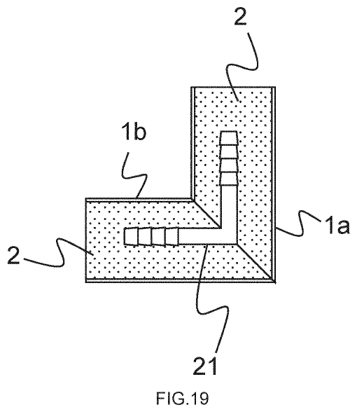

The drawing FIG. 19 shows two shaped parts (1a, 1b), assembled using an angled spline (21), in a side view. The two shaped parts (1a, 1b) are fastened against each other in the same way as with a biscuit joint (20), wherein the biscuit joint (20) is replaced by an angled spline (21).

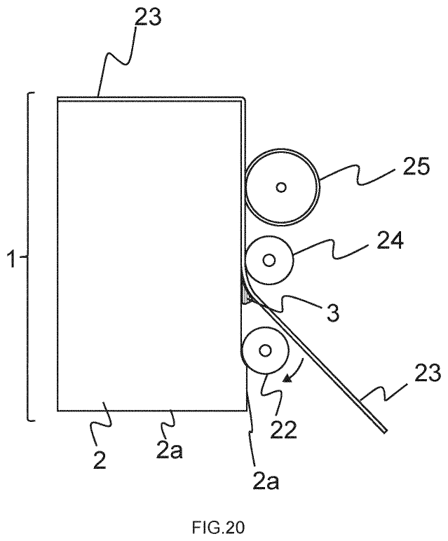

The drawing FIG. 20 shows the use of the shaped part (1) for the production of a piece of furniture, from above. The outer layer (4) of the shaped part (1) can be seen from above. The polyurethane piece (which cannot be seen here) is firstly given a smooth-grounding on the open side faces (2a) of the polyurethane piece (2), using a rough-milling cutter (22). The rough-milling cutter (22) is equipped with a grinding surface and rotates in the direction of the arrow. Herein it comes at the grinding surface into contact with the open side face (2a) of the polyurethane piece (2), wherein the open side face (2a) is given a smooth-grounding. When the rough-milling cutter (22) has been passed, an adhesive layer (3) is applied onto the open side face (2a) of the polyurethane piece (2), for example by means of a calender. Before the gluing, the adhesive layer (3) is heated to the temperature required for gluing, for example by a laser, by hot air or by near infrared radiation (NIR). For covering, a cover panel (23) made of aluminum or of a synthetic material, implemented of UV-stabilized polypropylene (PP), UV-stabilized polyethylene (PE), polyvinyl chloride (PVC) or acrylonitrile-butadiene-styrene copolymer (ABS), is then applied onto the adhesive layer (3). In an exemplary embodiment, the cover panel (23) made of synthetic material has a thickness of 1.0 mm to 2.0 mm. The application of the cover panel (23) is carried out by means of a roller (24). After the application of the cover panel (23), the resulting abutment edge of the cover panel (23) is smooth-polished by means of a form-milling cutter (25).

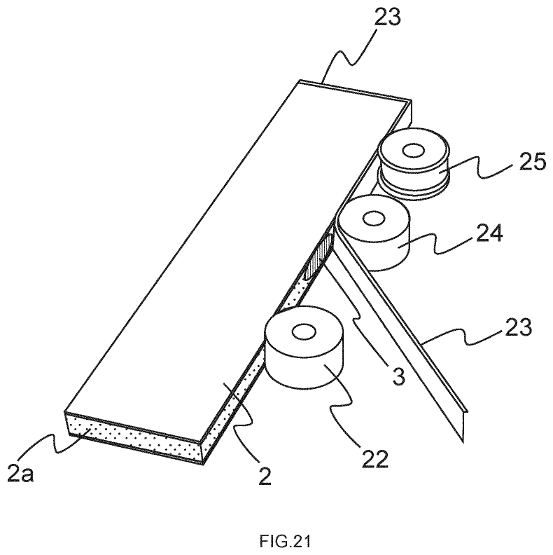

The drawing FIG. 21 shows the use of the shaped part (1) for the production of a piece of furniture, in an oblique front view. The polyurethane piece (2) and the outer layer (4) can be seen. When a rough-milling cutter (22) has passed over the open side face (2a) of the polyurethane piece (2), an adhesive layer (3) is applied. After this, a cover panel (23) is applied. The cover panel (23) is applied onto the adhesive layer (3) by means of a roller (24). In this way an abutment edge is created. After the roller (24), a form-milling cutter (25) also passes over the cover panel (23), such that the cover panel (23) obtains a smooth surface. After this procedure, the shaped part (1) can be used for the further production of a piece of furniture.

1. A shaped part for the production of pieces of furniture, comprising
an inner layer composed of a polyurethane piece, and
two outer layers, and
between the outer layers and the inner layer respectively one adhesive layer,
with a further adhesive layer on the other side of the polyurethane piece,
wherein
the polyurethane piece of the inner layer is composed of chopped and compressed shreds of polyurethane material mixed with material fibers and a binder, and has a density of 400-700 kg/m³, and
the outer layers have a layer thickness of 0.10-4.00 mm, and
the adhesive layers have an application quantity of 40 to 600 g/m².

2. The shaped part according to claim 1, wherein the material fibers are fiber particles realized from rock fibers, glass fibers, ceramic fibers or basalt fibers.

3. The shaped part according to claim 1, wherein the material fibers are fiber particles from carbon fibers.

4. The shaped part according to claim 1, wherein the outer layer consists of aluminum or of stone veneer.

5. The shaped part according to claim 1, wherein the material which the outer layer consists of is selected from high-pressure pressed laminate, continuous-pressed laminate, carbon fiber, resin-bound textiles, concrete, mineral-bound materials, ceramic materials, glasses, metals, weathering-resistant synthetic materials or precious woods.

6. The shaped part according to claim 1, wherein the adhesive layer consists of a 1 K-PUR prepolymer.

7. The shaped part according to claim 1, wherein the adhesive layer is constructed from an acrylate adhesive, from an in its initial state solvent-containing adhesive, from a dispersion adhesive or from a two-component adhesive.

8. The shaped part according to claim 1, wherein the shaped part is planar and has the shape of a panel.

9. The shaped part according to claim 1, wherein the polyurethane piece of the inner layer has a density of 550-660 kg/m³.

10. The shaped part according to claim 1, wherein the outer layer is varnished with a polyester varnishing, which has a layer thickness of 10-25 μm, as the outermost layer.

11. A method for producing a shaped part according to claim 1, comprising the method steps of
chopping a polyurethane foam in a chopper to produce polyurethane shreds, and
adding a binder to the polyurethane shreds and mixing, such that a mixture is created, and
compressing the mixture obtained in this way to produce a polyurethane piece, and
applying an adhesive layer onto at least one side of the polyurethane piece, and a further adhesive layer on the other side of the polyurethane piece, and
pressing outer layers, which have a layer thickness of 0.10-4.00 mm, onto the side of the polyurethane piece on which the adhesive layers have been applied,
wherein
material fibers are added to the polyurethane shreds before the compression, and the compression to produce a polyurethane piece is carried out with such a pressure and
such a duration that after the compression the polyurethane piece has a density of 400-700 kg/m³, and
the adhesive layers are applied onto the at least one side of the polyurethane piece with an application quantity of 40 to 600 g/m².

12. A use of a shaped part according to claim 1 for the production of pieces of furniture.

13. The use of a shaped part according to claim 12, wherein the production of the piece of furniture is carried out by drilling a screw thread into the shaped part and screwing at least two shaped parts with one another to form a piece of furniture.

14. A piece of furniture produced from a shaped part according to claim 1.
